(19) United States
(12) Patent Application Publication
(10) Pub. No.: US 2010/0026240 A1
(43) Pub. Date: Feb. 4, 2010

(54) LITHIUM ION BATTERY PACK CHARGING SYSTEM AND DEVICE INCLUDING THE SAME

(75) Inventors: Junwei Jiang, Woodbury, MN (US); Douglas C. Magnuson, Woodbury, MN (US); William M. Lamanna, Stillwater, MN (US); Phat T. Pham, Little Canada, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/182,531

(22) Filed: Jul. 30, 2008

(51) Int. Cl. H02J 7/04

(52) U.S. Cl. 320/116

(57) ABSTRACT

A lithium ion battery pack charging system comprises a lithium ion battery pack having positive and negative terminals and comprising a plurality of lithium ion cells connected in series and in electrical communication with the positive and negative terminals. Each of the plurality of lithium ion cells comprises an anode, a cathode, and electrolyte composition comprising a redox shuttle and a lithium salt at least partially dissolved in solvent. A charger in electrical communication with the positive and negative terminals is capable of charging the lithium ion battery pack at a first charge rate and a second lesser charge rate. The system further comprises a charger controller capable of monitoring input data and switching the charger from the first rate to the second changes based on the input data. A device comprising the lithium ion battery pack charging system is also disclosed.

### FIELD

The present disclosure relates broadly to systems for charging lithium ion battery packs.

### BACKGROUND

When properly designed and constructed, rechargeable lithium ion cells typically provide high energy content in a relatively small and lightweight device. Moreover, rechargeable lithium ion cells, and battery packs containing multiple lithium ion cells typically exhibit excellent charge-discharge cycle life with little or no hysteresis. However, lithium ion cells can have some shortcomings, including an inability to tolerate charging to potentials above the manufacturer's recommended end of charge potential without degradation in cycle life and/or cell failure, and difficulties in making large cells with sufficient tolerance to electrical and mechanical abuse for consumer applications.

Single and connected (e.g., series-connected) lithium ion cells typically incorporate charge control electronics to prevent individual cells from exceeding the recommended end of charge potential and to maintain charge balance between cells. This circuitry adds cost and complexity and has discouraged the use of lithium ion cells and batteries in low end electrical and electronic devices such as computers, flashlights, power tools, and even in motor vehicles, where the number of lithium ion cells may exceed one hundred. The recent development of redox shuttles suitable for use in lithium ion batteries allows improvement of the performance of lithium ion batteries. The term “redox shuttle” refers to a material that can provide oxidizable and reducible charge-transporting species that repeatedly transport charge between the negative and positive terminals of a lithium ion cell once the state of charge of the lithium ion cell reaches a desired value, typically corresponding to the lithium ion cell being fully charged. Although it is practical to use redox shuttles at relatively low overcharge charge rates, it is typically desirable that battery packs be chargeable at relatively high rates. Power dissipation at a high rate tends to create elevated temperatures which can shorten the service life.

It is common practice to use individual cell charge control circuitry with lithium ion battery packs including lithium ion cells that are not shuttle equipped. Monitoring individual lithium ion cells adds to the expense and complexity of battery packs with a high number of such cells arranged in series. An example is a large battery pack made for use in electric vehicle and/or hybrid electric vehicles.

Another technical challenge for large battery pack design is a state of charge imbalance between individual cells in a series string. This is caused most frequently by small faults in construction among cells in the battery pack. In general, such cell capacity imbalance adversely impacts battery pack cycling performance.

### SUMMARY

In one aspect, the present disclosure provides a lithium ion battery pack charging system comprising:

a lithium ion battery pack having positive and negative terminals, the lithium ion battery pack comprising a plurality of lithium ion cells connected in series and in electrical communication with the positive and negative terminals, each of the plurality of lithium ion cells comprising an anode, a cathode, and an electrolyte composition, wherein the electrolyte composition comprises a redox shuttle and a lithium salt at least partially dissolved in solvent;

a charger in electrical communication with the positive and negative terminals, the charger being capable of charging the lithium ion battery pack at at least a first charge rate and a second charge rate, wherein the second charge rate is greater than zero and less than the first charge rate; and

a charger controller in electrical communication with the charger, wherein the charger controller is capable of monitoring a voltage difference between the positive and negative terminals, calculating a rate of change of the voltage difference, and, depending at least in part on at least one of the voltage difference or the rate of change of the voltage difference, changing the first charge rate to the second charge rate.

In some embodiments, individual lithium ion cells of the plurality of lithium ion cells have a maximum difference in cell capacity of thirty percent, and wherein the lithium ion battery pack charging system is configured to charge the lithium ion battery pack at the second charge rate without stopping. In some embodiments, individual lithium ion cells of the plurality of lithium ion cells have a maximum difference in cell capacity of thirty percent, and wherein the lithium ion battery pack charging system is configured to charge the lithium ion battery pack at the second charge rate for a predetermined period of time. In certain of these embodiments, the lithium ion battery pack charging system is configured to turn off after the predetermined period of time. In certain embodiments, the second charge rate is sufficient to charge the lithium ion cells in the predetermined period of time; for example, not more than two hours. In some embodiments, the charger controller is integrally combined with the charger.

In some embodiments, depending on the voltage difference, the charger controller is capable of changing the first charge rate to the second charge rate. In some embodiments, depending on the rate of change of the voltage difference, the charger controller is capable of changing the first charge rate to the second charge rate. In some embodiments, the charger controller is further capable of monitoring a temperature of at least a portion of the lithium ion battery pack, and depending at least in part on at least one of the voltage difference or the rate of change of the voltage difference, and the temperature of the at least a portion of the lithium ion battery pack, changing the first charge rate to the second charge rate. In some embodiments, the charger controller is further capable of monitoring a temperature of at least a portion of the lithium ion battery pack, and calculating a rate of change of the temperature of the at least a portion of the lithium ion battery pack, and depending at least in part on at least one of the voltage difference or the rate of change of the voltage difference, and the rate of change of the temperature of the at least a portion of the lithium ion battery pack, changing the first charge rate to the second charge rate. In some embodiments, the redox shuttle comprises 1,4-di-t-butyl-2,5-dimethoxybenzene, and the electrolyte composition comprises ethylene carbonate, diethyl carbonate, ethyl methyl carbonate, and lithium hexafluorophosphate.

In another aspect, the present disclosure provides a device comprising a lithium ion battery pack charging system according to the present disclosure. In some embodiments, the redox shuttle comprises 1,4-di-t-butyl-2,5-dimethoxybenzene, and the electrolyte composition comprises ethylene carbonate, diethyl carbonate, ethyl methyl carbonate, and lithium hexafluorophosphate.

Advantageously, lithium ion battery pack charging systems according to the present disclosure eliminate the need for supervisory circuitry presently included in lithium ion battery packs to monitor individual cell voltages. Further, lithium ion battery pack charging systems according to the present disclosure are especially useful for charging (and recharging) lithium ion battery packs having unbalanced lithium ion cells.

As used herein,

“rate” refers to a rate with respect to time unless otherwise specified.

### BRIEF DESCRIPTION OF THE DRAWING

FIG. 1 is a block diagram of an exemplary lithium ion battery pack charging system according to the present disclosure.

### DETAILED DESCRIPTION

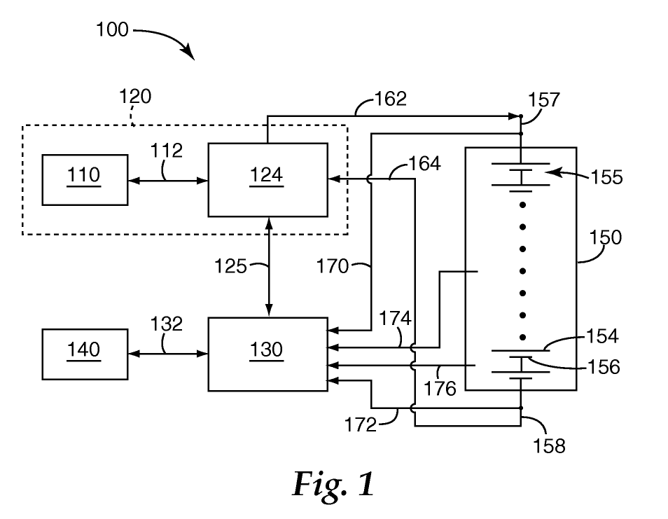

Referring now to FIG. 1, exemplary lithium ion battery pack charging system 100 according to the present disclosure comprises lithium ion battery pack 150 having positive terminal 157 and negative terminal 158. As shown, lithium ion battery pack 150 comprises a plurality of lithium ion cells 155 connected in series and in electrical communication with positive and negative terminals (157, 158). Each of the plurality of lithium ion cells 155 comprises an anode (154), a cathode (156), and an electrolyte composition (not shown).

Charger 120 comprises power supply 110 (e.g., an AC adapter) in electrical communication with charge management integrated circuit (IC) 124 through first circuit 112. Charger 120 is in electrical communication with the positive and negative terminals (157, 158). Charger 120 is capable of charging lithium ion battery pack 150 at a first charge rate and a second charge rate that is greater than zero and less than the first charge rate.

Charger controller 130 is in electrical communication via second circuit 125 with charger 120 via charge management integrated circuit 124. Charger controller 130 is in electrical communication with optional display unit 140 (e.g., and LED display) through third circuit 132. Charger controller 130 is capable of dynamically monitoring (e.g., during charging of the lithium ion battery pack 150) the voltage difference between positive and negative terminals (157, 158) through fourth and fifth circuits (170, 172) and determining a rate of change of the voltage difference, and based at least in part on the voltage difference or its rate of change, changing the first (higher) charge rate to the second (lower) charge rate.

Optionally, charger controller 130 is capable of receiving information concerning the temperature of one or more regions of the lithium ion battery pack through sixth and seventh circuits 174, 176. Based on the received temperature information and/or the rate of change of the that information, the charger controller may change the charge rate of the charger 120 to one or more other levels (typically lower), including in some cases reducing the charge rate to zero.

In operation, constant current is supplied to the lithium ion battery pack at the relatively higher first rate until at least one cell begins to shuttle. The onset of shuttling is associated with a rise in the voltage difference between the positive and negative terminals of the lithium ion battery pack, typically to a predetermined voltage range. Accordingly, either the rate of increase in voltage difference or the actual voltage difference may be used to determine when shuttling occurs, and hence when the charge rate should be changed to the second (lower) charge rate. In addition to monitoring the voltage difference between the positive and negative terminals, the temperature of one or more regions within the lithium ion battery pack may also be monitored; for example, as a backup and/or as an indicator of lithium ion battery pack failure. For example, the charger may be configured to further reduce, or stop, the charge rate in response to a rise in the lithium ion battery pack internal temperature (e.g., either the rate of the measured temperature rise, or the measured temperature).

The lithium ion battery pack comprises at least two lithium ion cells having redox shuttles connected in series. Optionally, it may contain additional lithium ion cells that are connected in parallel. The lithium ion battery pack may, for example, be substantially contained within a housing or the positive and negative terminals may serve to substantially contain the lithium ion cells.

The lithium ion cells are typically selected to have the same capacity subject to cell variability. Small faults with any given cell can cause that cell to lose charge and create a state of charge less than its series connected neighbors. Differences may tend to accentuate over time, however, nominally identical lithium ion cells generally exhibit some variation in capacity, especially after extended use. Such variation in capacity is typically less than 30 percent, more typically less than 20 or even less than 10 percent; however, it can be larger. This issue creates a need for rebalancing the lithium ion cells. Once the lithium ion cells are all charged to their maximum state of charge the lithium ion battery pack will then deliver the most energy upon discharge. Lithium ion cells that are capable of shuttling are therefore a key element in the charging system.

Lithium ion cells may be made, for example, by taking at least one each of a cathode and an anode (e.g., as described hereinbelow) and contacting them with an electrolyte composition. A microporous separator, such as CELGARD 2400 microporous material, available from Celgard of Charlotte, N.C., may be used to prevent the contact of the anode directly with the cathode.

The cathode (positive electrode) may be made from an electrode composition including, for example: LiMn₂O₄; LiFePO₄; LiCoO₂; mixed metal oxides of cobalt, manganese, and nickel such as those described in U.S. Pat. Nos. 6,964,828 B2 (Lu et al.) and 7,078,128 B2 (Lu et al.); and nanocomposite cathode compositions such as those described in U.S. Pat. No. 6,680,145 B2 (Obrovac et al.). Other cathodes suitable for use in lithium ion electrochemical cells may also be used. Typically, the foregoing compositions are combined (e.g., using pressure) with a binder and optional additional additives such as will be familiar to those skilled in the art. The cathode may contain additives as will be familiar to those skilled in the art, e.g., carbon black, flake graphite and the like. As will be appreciated by those skilled in the art, the cathode may be in any convenient form including foils, plates, rods, pastes or as a composite made by forming a coating of the cathode material on a conductive current collector or other suitable support.

For example, the cathode composition may include an electrically conductive diluent to facilitate electron transfer from the powdered material to a current collector. Electrically conductive diluents include, but are not limited to, carbon (e.g., carbon black for anodes and carbon black, flake graphite and the like for cathodes), metal, metal nitrides, metal carbides, metal silicides, and metal borides. Representative electrically conductive carbon diluents include carbon blacks such as SUPER P and SUPER S carbon blacks (both from MMM Carbon, Belgium), SHAWANIGAN BLACK (Chevron Chemical Co. of Houston, Tex.), acetylene black, furnace black, lamp black, graphite, carbon fibers, single-walled carbon nanotubes, multiple-walled carbon nanotubes, and combinations thereof.

The anode (negative electrode) may be made from compositions that include lithium, carbonaceous materials, silicon alloy compositions and lithium alloy compositions. Exemplary carbonaceous materials include synthetic graphites such as mesocarbon microbeads (MCMB) (available from E-One Moli/Energy Canada Ltd., Vancouver, BC, Canada), SLP30 (available from TimCal Ltd., Bodio, Switzerland), natural graphites and hard carbons. Useful anode materials also include alloy powders or thin films. Such alloys may include electrochemically active components such as silicon, tin, aluminum, gallium, indium, lead, bismuth, and zinc and may also comprise electrochemically inactive components such as iron, cobalt, transition metal silicides and transition metal aluminides.

Lithium salt(s) suitable for use in lithium ion cells are well known in the art and should generally be selected so that they do not appreciably degrade during use in a lithium-ion battery. Exemplary lithium salt(s) include LiPF₆, LiBF₄, LiClO₄, lithium bis(oxalate)borate, LiN(SO₂CF₃)₂, LiN(SO₂C₂F₅)₂, LiAsF₆, LiC(SO₂CF₃)₃, LiB(C₆H₅)₄, LiO₃SCH₃, LiO₃SCF₃, LiCl, LiBr, and combinations thereof.

As used herein, the term “solvent” refers to one or more compounds that collectively dissolve at least a portion of the lithium salt. In general, the solvent is homogeneous, although a minor amount of phase separation may be acceptable under some circumstances. The solvent may be a liquid, gel, or solid; typically liquid. In general, compounds used in the solvent should be inert to normal operating conditions in the lithium ion cell. Exemplary solvents include: glycol ethers such as 1,2-dimethoxyethane and 1,2-diethoxyethane; lactones such as γ-butyrolactone and valerolactone; cyclic ethers such as tetrahydrofuran, 2-methyltetrahydrofuran, 1,3-dioxolane, and 4-methyl-1,3-dioxolane; sulfones such as sulfolane and methylsulfolane; carbonates such as ethylene carbonate, propylene carbonate, butylene carbonate, vinylene carbonate, dimethyl carbonate, diethyl carbonate, ethyl methyl carbonate, and vinylethylene carbonate. Additional solvents are disclosed in commonly-assigned U.S. patent application Ser. No. 12/181,625 (Pham et al.), filed Jul. 29, 2008.

Exemplary electrolyte compositions include those comprising lithium hexafluorophosphate, ethylene carbonate, diethyl carbonate, and ethyl methyl carbonate, in a weight ratio of 13:13:26:48, respectively.

Any redox shuttle suitable for use in lithium ion cells may be used. Typically, the redox shuttle is selected to operate at a voltage that is 0.1 to 0.6 volts above the voltage of the positive electrode at a desired state of charge, although this is not a requirement. Useful redox shuttles may include, for example, various metallocenes, tetracyanoethylene, tetramethylphenylenediamine, dihydrophenazine derivatives bearing either 2-hydroxypropyl or ethyl substituents on both N atoms, and various substituted aromatic (e.g., 2,5-di-tert-butyl-1,4-dimethoxybenzene, hexaethylbenzene, biphenyl, difluoroanisole), and heterocyclic compounds (e.g., bipyridyl, thianthrene, 2,7-diacetyl thianthrene, and certain phenothiazine based compounds). Additional useful redox shuttles may include those described in U.S. Pat. Nos. 5,709,968 (Shimizu); 5,763,119 (Adachi), 5,536,599 (Alamgir et al.), 5,858,573 (Abraham et al.), 5,882,812 (Visco et al.), 6,004,698 (Richardson et al.), 6,045,952 (Kerr et al.), and 6,387,571 B1 (Lain et al.); and in U.S. Pat. Appl. Publ. Nos. 2005/0221168 A1, 2005/0221196 A1, 2006/0263696 A1, and 2006/0263697 A1 (each to Dahn et al.).

The capacity of a cell (cell capacity) is a measure of the amount of energy that it can deliver in a single discharge. Cell capacity is normally listed in units of ampere-hours. The term “C” is commonly used to signify a charge (or discharge) rate equal to the cell capacity divided by 1 hour. For example, C for a 1.6 ampere-hour battery would be 1.6 amperes.

In terms of cell charging, C is equal to the charger current output divided by the cell capacity. For example, if a 4 ampere-hour cell is charged by a 2 ampere charger, the charge rate is 0.5 C. Likewise, if a two ampere charger is used to charge a twenty ampere-hour cell, then the battery charge rate is 0.1 C.

Typically, the charger delivers a substantially constant current at discrete level(s), which may be a single level or multiple different levels. For example, it may deliver a substantially constant higher current at the first charge rate (e.g., fast-charging), and a substantially constant lower current at the second charge rate (e.g., slow-charging). In some embodiments, the charger may not deliver substantially constant current at each discrete level (e.g., the current may vary significantly within specified upper and lower bounds for one or more of the charging levels). Chargers capable of charging a multiple discrete charge rates (e.g., a high charge rate and a low rate) are well known in the art and widely available from commercial sources

Typically, the charge rates are adapted for a specific lithium ion battery pack, although the charger may have multiple independent operating modes, each adapted for a different lithium ion battery pack type and/or configuration. Typically, the first charge rate is in a range of from about C/10 to at least about 2 C for the same lithium ion battery pack; for example, in a range of from about C/2 to about 2 C, although other values may also be used. Likewise, the second charge rate is typically in a range of from about C/30 to about C/10 for a given lithium ion battery pack; for example, in a range of from about C/20 to about C/10, although other values may also be used.

For example, the lithium ion battery pack charging system may be configured such that, once switched to the second charging rate, charging continues for a predetermined period of time (e.g., about 10, 20, 30, 60, or 90 minutes or about 2, 3, 4, 5, 6, 12, or even about 24 hours) or charging may be continued until a triggering event such as a temperature rise or voltage increase occurs that causes the charger controller to shut off the charger. If desired, charging at the second charge rate may be continued indefinitely subject to manual termination. Typically, the period of time will be specified such that upon its conclusion the battery is substantially fully charged.

The charger may be a standalone unit or several electrically connected components. For example, the charger may comprise an AC adapter electrically connected to a charge management integrated circuit (IC) capable of managing current delivered by the AC adapter to the lithium ion battery pack, as shown in FIG. 1. Examples of useful charge management integrated circuits include those marketed by Texas Instruments, Inc. of Dallas, Tex., as BQ24100, BQ24103, BQ24103A, BQ24105, BQ24108, BQ24109, BQ24113, BQ24113A, and BQ24115.

Likewise, the charger controller may be a standalone unit or several electrically connected components. For example, the charger controller may comprise a mixed signal microcontroller integrated chip. Examples of suitable such mixed signal microcontrollers include those marketed by chips include management integrated circuits include those marketed by Texas Instruments as MSP430X20X1, MSP430X20X2, and MSP430X20X3.

Lithium ion battery pack charging systems according to the present disclosure may be included in a variety of devices, including, for example, portable computers, tablet displays, toys, personal digital assistants, mobile telephones, motorized devices (e.g., personal or household appliances and motor vehicles), instruments, illumination devices (e.g., flashlights), and heating devices.

All patents and publications referred to in this application are hereby incorporated by reference herein in their entirety. Various modifications and alterations of this disclosure may be made by those skilled in the art without departing from the scope and spirit of this disclosure, and it should be understood that this disclosure is not to be unduly limited to the illustrative embodiments set forth herein.

What is claimed is:

1. A lithium ion battery pack charging system comprising:
a lithium ion battery pack having positive and negative terminals, the lithium ion battery pack comprising a plurality of lithium ion cells connected in series and in electrical communication with the positive and negative terminals, each of the plurality of lithium ion cells comprising an anode, a cathode, and an electrolyte composition, wherein the electrolyte composition comprises a redox shuttle and a lithium salt at least partially dissolved in solvent;
a charger in electrical communication with the positive and negative terminals, the charger being capable of charging the lithium ion battery pack at at least a first charge rate and a second charge rate, wherein the second charge rate is greater than zero and less than the first charge rate; and
a charger controller in electrical communication with the charger, wherein the charger controller is capable of monitoring a voltage difference between the positive and negative terminals, calculating a rate of change of the voltage difference, and, depending at least in part on at least one of the voltage difference or the rate of change of the voltage difference, changing the first charge rate to the second charge rate.

2. The lithium ion battery pack charging system of claim 1, wherein individual lithium ion cells of the plurality of lithium ion cells have a maximum difference in cell capacity of one hundred percent, and wherein the lithium ion battery pack charging system is configured to charge the lithium ion battery pack at the second charge rate without stopping.

3. The lithium ion battery pack charging system of claim 1, wherein individual lithium ion cells of the plurality of lithium ion cells have a maximum difference in cell capacity of one hundred percent, and wherein the lithium ion battery pack charging system is configured to charge the lithium ion battery pack at the second charge rate for a predetermined period of time.

4. The lithium ion battery pack charging system of claim 2, wherein the lithium ion battery pack charging system is configured to turn off after the predetermined period of time.

5. The lithium ion battery pack charging system of claim 3, wherein the second charge rate is sufficient to charge the lithium ion cells in the predetermined period of time.

6. The lithium ion battery pack charging system of claim 5, wherein the predetermined period of time is not more than two hours.

7. The lithium ion battery pack charging system of claim 1, wherein the charger controller is integrally combined with the charger.

8. The lithium ion battery pack charging system of claim 1, wherein depending on the voltage difference, the charger controller is capable of changing the first charge rate to the second charge rate.

9. The lithium ion battery pack charging system of claim 1, wherein depending on the rate of change of the voltage difference, the charger controller is capable of changing the first charge rate to the second charge rate.

10. The lithium ion battery pack charging system of claim 1, the charger controller is further capable of monitoring a temperature of at least a portion of the lithium ion battery pack, and depending at least in part on at least one of the voltage difference or the rate of change of the voltage difference, and the temperature of the at least a portion of the lithium ion battery pack, changing the first charge rate to the second charge rate.

11. The lithium ion battery pack charging system of claim 1, the charger controller is further capable of monitoring a temperature of at least a portion of the lithium ion battery pack, and calculating a rate of change of the temperature of the at least a portion of the lithium ion battery pack, and depending at least in part on at least one of the voltage difference or the rate of change of the voltage difference, and the rate of change of the temperature of the at least a portion of the lithium ion battery pack, changing the first charge rate to the second charge rate.

12. The lithium ion battery pack charging system of claim 1, wherein the redox shuttle comprises 1,4-di-t-butyl-2,5-dimethoxybenzene, and wherein the electrolyte composition comprises ethylene carbonate, diethyl carbonate, ethyl methyl carbonate, and lithium hexafluorophosphate.

13. A device comprising the lithium ion battery pack charging system of claim 1.

14. The device of claim 13, wherein the redox shuttle comprises 1,4-di-t-butyl-2,5-dimethoxybenzene, and wherein the electrolyte composition comprises ethylene carbonate, diethyl carbonate, ethyl methyl carbonate, and lithium hexafluorophosphate.
